(19) United States
(12) Patent Application Publication
(10) Pub. No.: US 2025/0224867 A1
(43) Pub. Date: Jul. 10, 2025

(54) SHARED PARITY RELEASE AND RECONSTRUCTION

(71) Applicant: Micron Technology, Inc., Boise, ID (US)

(72) Inventors: Ting Luo, Santa Clara, CA (US); Xiangang Luo, Fremont, CA (US); Yuqi Zhu, Milpitas, CA (US); Guang Hu, Mountain View, CA (US); Chun Sum Yeung, San Jose, CA (US)

(21) Appl. No.: 19/000,351

(22) Filed: Dec. 23, 2024

Related U.S. Application Data
(60) Provisional application No. 63/618,162, filed on Jan. 5, 2024.

(51) Int. Cl. G06F 3/06

(52) U.S. Cl. CPC G06F 3/0608; G06F 3/0659; G06F 3/0679

(57) ABSTRACT

Methods, systems, and devices for shared parity release and reconstruction are described. A memory system may receive a command to store data to non-volatile memory associated with the memory system. The memory system may write the data to the non-volatile memory device at a location indicated by one or more cursors in a volatile memory of the memory system and generate first parity information based on the data. The memory system may determine that a size of the data indicated by the one or more cursors satisfies a threshold and may release the first parity information from the volatile memory. The memory system may generate second parity information using a portion of the data associated with the first parity information.

### CROSS REFERENCE

The present Application for Patent claims priority to U.S. Patent Application No. 63/618,162 by Luo et al., entitled “SHARED PARITY RELEASE AND RECONSTRUCTION,” filed Jan. 5, 2024, which is assigned to the assignee hereof, and which is expressly incorporated by reference in its entirety herein.

### TECHNICAL FIELD

The following relates to one or more systems for memory, including shared parity release and reconstruction.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports shared parity release and reconstruction in accordance with examples as disclosed herein.

FIGS. 2 and 3 show examples of processes that support shared parity release and reconstruction in accordance with examples as disclosed herein.

FIG. 4 shows a block diagram of a memory system that supports shared parity release and reconstruction in accordance with examples as disclosed herein.

FIG. 5 shows a flowchart illustrating a method or methods that support shared parity release and reconstruction in accordance with examples as disclosed herein.

### DETAILED DESCRIPTION

Some memory systems may include a quantity of memory zones. For example, a memory system may be associated with a zoned namespace configuration that may divide non-volatile memory (e.g., NAND memory) into one or more independent zones that may support specific data or operations. A zone may include one or more memory block. In some zoned namespace configurations, blocks in a zone may be written to sequentially. The use of these zones may enable multiple components or systems to share the non-volatile memory of the memory system, which may lead to decreased costs and higher performance.

In some examples, the memory system may protect data associated with (e.g., stored in) these zones using parity information bits that may be stored in volatile memory of the memory system. For example, the memory system may implement redundant array of independent NAND (RAIN) techniques to protect information stored to the memory system. Typically, RAIN techniques may be associated with a single cursor. However, implementing separate parity storage for each of the zones may utilize a large quantity of the volatile memory. Thus, in some examples, the memory system may perform one or more operations (e.g., XORing operations) to combine parity information bits associated with each of the zones into one large parity. However, combining parity information across multiple zones may reduce the quality of protection provided and, in the case that the parity is flushed (e.g., released, removed, deleted) without proper storage, data may be lost. As such, more efficient and storage-saving parity release and reconstruction techniques may be beneficial to the memory system.

To increase storage efficiency and decrease data loss, a zoned memory system may store parity information associated with data of multiple zones in one parity (e.g., parity location) until a threshold size of the data stored in the cursors of the zones is reached. Upon the threshold size being reached, the memory system may release the parity information and rebuild a new parity information utilizing portions of the data that were formerly protected by the released parity information. For example, the memory system may receive a command to store data to non-volatile memory associated with the memory system. The memory system may, in response to receiving the command, write the data to a location in the non-volatile memory that may be indicated by one or more cursors stored in the volatile memory. The memory system may generate one or more parity information bits based on the received data (e.g., and other data stored in the non-volatile memory). In the case that the memory system may determine that a size of the data associated with the stored parity bits satisfies a threshold, the memory system may release the generated parity information from the volatile memory. After releasing the parity information, the memory system may generate a second parity information using a portion of the data that was formerly protected by the original parity information (e.g., two word lines of one or more of the zones) such that the memory system may fully protect new data being written to the non-volatile memory indicated by cursors in the volatile memory.

In addition to applicability in memory systems described herein, techniques for shared parity release and reconstruction may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, errors that occur as part of normal operations, unauthorized access, or modification of data in security-critical devices such as vehicles, healthcare devices, and others may be especially concerning. Implementing the techniques described herein may improve the security of electronic devices and systems by increasing storage efficiency and decreasing data loss and may prevent or mitigate unauthorized access to data or other information, incur lower latency costs (e.g., by implementing it at hardware level), among other benefits.

Features of the disclosure are illustrated and described in the context of systems, devices, and circuits. Features of the disclosure are further illustrated and described in the context of processes and flowcharts.

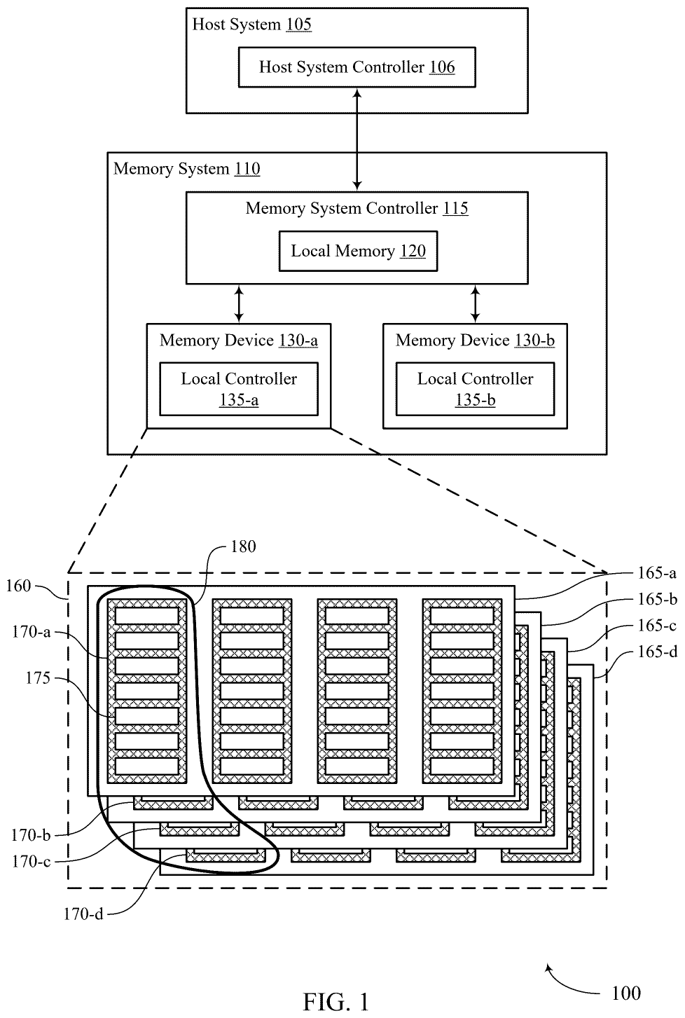

FIG. 1 shows an example of a system 100 that supports shared parity release and reconstruction in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically crasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained, and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support shared parity release and reconstruction. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the system 100 may be characterized by a zoned namespace (ZNS) interface configuration. A ZNS interface may include the division of the memory system (e.g., NAND memory) into independent zones that may support specific data or workload types. For example, the ZNS interface may extend one or more protocols associated with the NVMe protocol to provide a LBA space that the host system 105 may utilize in directing commands to and data from for that particular host system. The ZNS interface may divide the space of the memory system into one or more zones (e.g., chunks of pages, superblocks), where each of the zones may be treated as an isolated namespace. The host system 105 may sequentially write to each of the zones, and may randomly read from the zones (e.g., the host system 105 may read from the zones in an order different than a write order). Because the host system 105 may be enabled to direct workload to and from specific zones, the use of volatile memory (e.g., DRAM) may decrease which may result in increased efficiency and performance of the system 100.

The system 100 may implement RAIN protection to protect the data stored in each of the zones. To protect data stored in the non-volatile memory of the memory devices 130, volatile memory (e.g., SRAM) of the local memory 120 included in the memory system controller 115 may store redundant parity information associated with parity information of each page of data stored in the memory devices 130. The memory system controller 115 may compare the redundant parity and the parity associated with each page of data to determine if an error has occurred during the storing of the data in the memory devices 130. In the case of a ZNS configuration, redundant parity information may be generated for each cursor of each zone, which may result in the generation of a large quantity of parity information. For example, in the case that a single zone may include 24 pages and each page may be associated with 16 kilobytes (KB) of information, a controller may generate 384 KB of redundant parity information for a single zone (e.g., 24×16 KB=384 KB). In some examples, a ZNS configuration may include seven zones, where each zone includes an open cursor and block of pages (e.g., 24 pages). As such, the controller may generate seven-times the quantity of parity information (e.g., 7×384 KB=2688 KB), which may utilize a large quantity of volatile memory in storing.

To avoid storing a large quantity of parity information in the local memory 120, the parity information of the zones may be consolidated. For example, the system 100 may not include DRAM to store parity information and storing a large quantity of parity information in the volatile memory (e.g., SRAM) of the local memory 120 may be expensive. Rather than provide SRAM of the local memory 120 for the separate parity information of each zone, the memory system controller 115 may combine (e.g., XOR) the parities of each zone together such that the total quantity of parity information for the zones is less than the added quantity of parity information for each separate zone (e.g., the size of parity information for all the zones is the same as the size of parity information for a single zone, 384 KB). The local memory 120 may store the parity information (e.g., the XOR'ed parity information) associated with the multiple zones, which may increase efficiency of the system 100.

The local memory 120 of the memory system 110 may store the parity information associated with the zones until a threshold size of the data protected by the parity is reached and, upon the threshold size being reached, the memory system may release the parity information bits and rebuild a new parity utilizing one or more portions of the data formerly protected by the original parity information. For example, the memory system 110 may receive a command to store data to the zones of the memory devices 130. The memory system 110 (e.g., or the memory system controller 115) may, in response to receiving the command, generate parity information based on the received data (e.g., and other data stored in the memory devices 130) and store the parity information to the local memory 120. In the case that the memory system 110 may determine that a size satisfies a threshold, the memory system 110 may release the generated parity information from the volatile memory. In some examples, the trigger for releasing the parity information may occur in response to the memory system 110 determining that the size of the data indicated by a cursor for a single zone satisfies the threshold. In some examples, the trigger for releasing the parity information may occur in response to the memory system 110 determining that a quantity of filled word lines in one or more of the zones satisfies the threshold. Upon releasing the parity information, the memory system 110 may generate second parity information using a portion of the data formerly protected by the released parity information such that the data associated with each zone may be protected in the case of system failure or error detection.

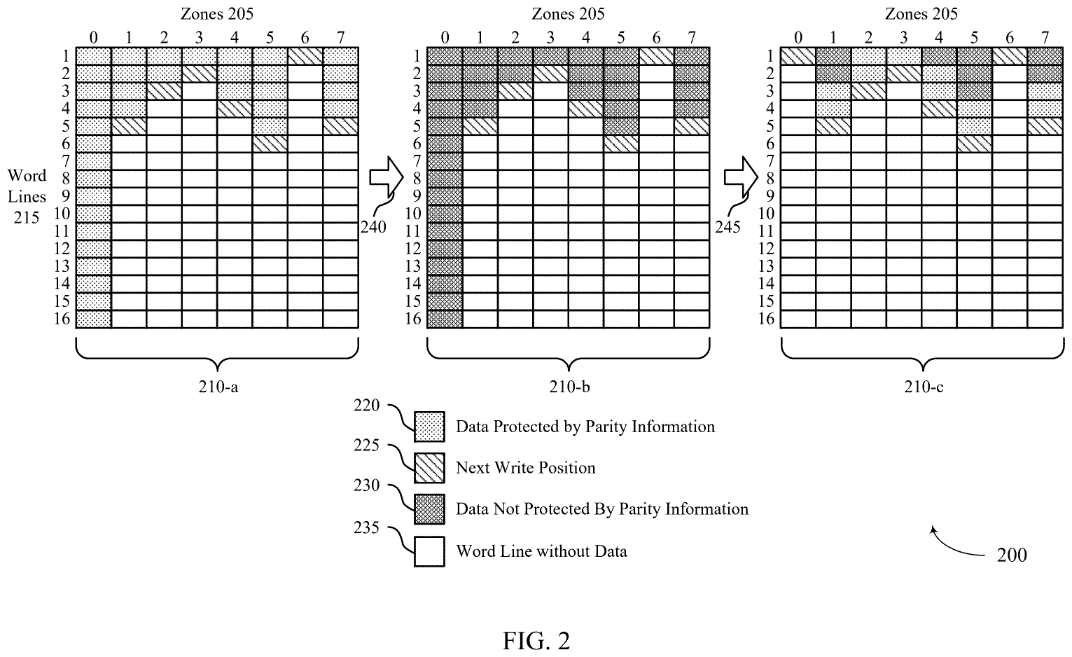

FIG. 2 shows an example of a process 200 that supports shared parity release and reconstruction in accordance with examples as disclosed herein. The process 200 may be implemented by a system 100 as described with reference to FIG. 1, or aspects thereof. The process 200 may include zones 205 (e.g., zones 0-7) that may be examples of zones as described with reference to FIG. 1. Each of the zones 205 may include word lines 215 that may be examples of the pages as described with reference to FIG. 1.

The process 200 may be used by a system 100 that uses a zone namespace configuration. In a zone namespace configuration, the memory system may be divided into multiple zones. Each zone may include a plurality of blocks. At any given time, each zone may have an open block that is being written to by write commands for the associated host system. To manage the open block, information stored in the volatile device may be used to track which page to write to the open block for the next command by something referred to as a cursor. Each zone may be associated with an open block in non-volatile memory of the system and each open block may be associated with its own cursor in the volatile memory of the system. The zone configurations 210-a, 210-b, and 210-c show the status of open blocks stored in non-volatile memory and indicated by cursors for different zones (e.g., cursors stored in the volatile memory device) at different times. The zone configuration 210-a may include an example of the zones 205 prior to a memory system of a memory system releasing parity information associated with the data of the zones 205 (e.g., prior to parity information release event 240). In some cases, the memory system may receive one or more commands to write data to the zones 205. Upon receiving the command, the memory system may write the data to a next write position 225 of one of the zones 205 as indicated by the cursor for the open block of that zone. In the case that the memory system writes the data to the next write position 225, the next write position 225 (e.g., the open cursor) may move to the next sequential word line (e.g., page). The zone configurations 210-a, 210-b, and 210-c also shown word lines (e.g., pages) without data 235. In some examples, the memory system may write the data to a specific zone in a sequence of zones. The memory system may also generate a copy of one or more parity bits associated with the data stored to the zones 205 and may update parity information stored in volatile memory of the memory system and associated with the zones 205 such that the data stored to the open block of the zones 205 in the non-volatile memory device may be data protected by parity information 220.

In some examples, a parity information release event 240 may be initiated. For example, in response to the memory system generating the parity information, the memory system may determine that a size of the data protected by the parity information satisfies a threshold size. For example, the memory system may determine that the word lines 215 of one of the zones 205 (e.g., zone 0, or any of the zones 0-7) may be filled with data protected by parity information 220. In response to determining that the zone is full (e.g., one way to determine that the threshold size is satisfied), the controller may release the parity information in the parity information release event 240. In some examples, the parity information release event 240 may include erasing (e.g., deleting, invalidating, over-writing) the parity information from the volatile memory (e.g., SRAM). In other examples, the parity information release event 240 may include transferring the parity information from the volatile memory (e.g., SRAM) of the memory system to non-volatile memory (e.g., NAND) of the memory system.

The process 200 may include a zone configuration 210-b. The zone configuration 210-b may be an example of the zones after the parity information release event 240. After parity information is released, the zones 205 may include data that may not be protected by parity information 230. For example, because the memory system released the parity information from the volatile memory (e.g., the parity information release), the data previously associated with the parity information may not be protected by parity information and thus data may be lost in the case that an error or failure of the memory system may occur.

Because the trigger for this parity information release event was that the open block of one of the zones (e.g., zone 0) became full, the memory system may release the parity information from the volatile device associated with the open block of that zone and open a new block for that zone. This may result in one the open block for that zone not having any parity information protecting it in the volatile memory.

To protect the data, the memory system may initiate a parity information reconstruction event 245, which may result in a zone configuration 210-c. If there is no parity information stored in the volatile memory, there is a possibility that an error may occur in newly written data may be undetected. To increase the effectiveness of the parity information, new parity information may be generated from partial amounts of data stored in the zone configuration of the non-volatile memory. The memory system may utilize (e.g., retrieve) a portion of the stored data to generate the new parity information (e.g., generate second parity information) such that data stored in the non-volatile memory may be protected. In some cases, the memory system may utilize one or more (e.g., 2) of the word lines of data protected by parity information 220 and last written to regenerate portions of the parity information such that the memory system may correct one or more errors that occur when new data is written to the zone configuration 210-c.

The memory system may generate new parity information using a quantity of most-recently written word lines for each zone. In the illustrative example, the last two written word lines (when available) are used to generate the new parity information. Specifically, the new parity information is generated using word lines 3 and 4 of zone 1, word lines 1 and 2 of zone 2, word line 1 of zone 3, word lines 2 and 3 of zone 4, word lines 4 and 5 of zone 5, and word lines 3 and 4 of zone 7. Additionally, in the case that one or more of the zones 205 may not have stored any data (e.g., zone 0, zone 6) or may not have the threshold quantity of word lines filled (e.g., zone 3), those zones may either not be used to generate the new parity information or a reduced quantity of word lines from that zone may be used to generate the new parity information. While generating the new parity information is shown as using data from two filled word lines from each zone with sufficient data stored to them, any quantity of word lines may be used to generate the new parity information. For example, the new parity information may be generated using one, two, three, four, five, six, seven, or eight filled word lines associate with one or more of the zones.

In some examples, the memory system may receive another write command upon generating the new parity information (e.g., generating the second parity information). The memory system may store data associated with the new write command to the zones 205 (e.g., write the data to the next write position 225 of the next zone 205 in the sequence) and may generate one or more other parity bits associated with the new data. The memory system may update the parity information (e.g., generate third parity information) associated with the zones 205 such that the new data and the stored data may be protected by parity information.

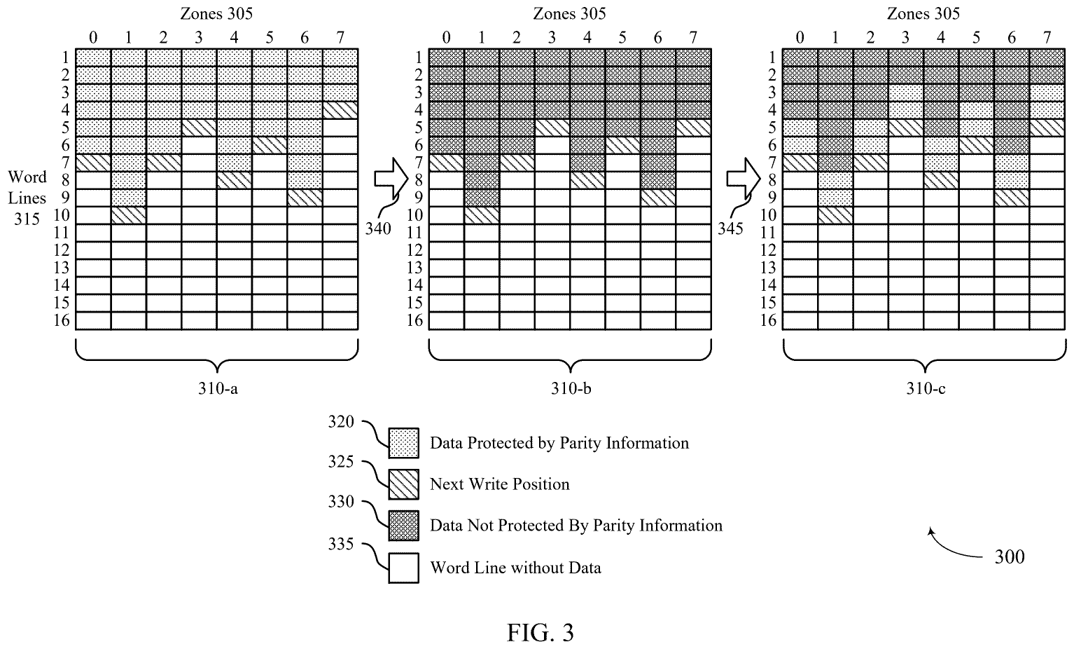

FIG. 3 shows an example of a process 300 that supports shared parity release and reconstruction in accordance with examples as disclosed herein. The process 300 may be implemented by a system 100 as described with reference to FIG. 1, or aspects thereof. The process 300 may include zones 305 (e.g., zones 0-7) that may be examples of zones as described with reference to FIG. 1. Each of the zones 305 may include word lines 315 that may be examples of the pages as described with reference to FIG. 1. The zone configurations 310-a, 310-b, and 310-c may be examples of the zone configurations 210-a, 210-b, and 210-c described with reference to FIG. 2.

The process 300 may include a zone configuration 310-a. The zone configuration 310-a may include an example of the zones 305 prior to a memory system of a memory system releasing parity information associated with the data of the zones 305 (e.g., prior to parity information release event 340). In some cases, the memory system may receive one or more commands to write data to the zones 305. Upon receiving the command, the memory system may write the data to a next write position 325 of one of the zones 305 as indicated by the cursor associated with the open block of that zone. In the case that the memory system writes the data to the next write position 325, the next write position 325 (e.g., the open cursor) may move to the next sequential word line (e.g., page). The zone configurations 310-a, 310-b, and 310-c also shown word lines (e.g., pages) without data 335. In some examples, the memory system may write the data to a specific zone in a sequence of zones. The memory system may also generate a copy of one or more parity bits associated with the data stored to the zones 305 and may update parity information stored in volatile memory of the memory system and associated with the zones 305 such that the data stored to the open block of the zones 305 in the non-volatile memory device may be data protected by parity information 320.

In some examples, a parity information release event 340 may be initiated. For example, in response to the memory system generating the parity information, the memory system may determine that a size of the data protected by the parity information satisfies a threshold size. The threshold size may be associated with a quantity (e.g., size) of the word lines 315 that are filled across the open blocks stored in the non-volatile device for a plurality of zones. For example, the memory system may determine that a quantity of the word lines 315 across all the zones 305 (e.g., zones 0-7) that are filled with data protected by parity information 320 satisfy the size threshold. In response to determining that the quantity of protected word lines (e.g., a size of filled word lines) satisfies a threshold size, the memory system may release the associated parity information in the parity information release event 340. In some examples, the parity information release event 340 may include erasing (e.g., deleting, invalidating, over-writing) the parity information from the volatile memory (e.g., SRAM). In other examples, the parity information release event 340 may include transferring the parity information from the volatile memory (e.g., SRAM) of the memory system to non-volatile memory (e.g., NAND) of the memory system.

The process 300 may include a zone configuration 310-b. The zone configuration 310-b may be an example of the zones after the parity information release event 340. After parity information is released, the zones 305 may include data that may not be protected by parity information 330. For example, because the memory system released the parity information from the volatile memory (e.g., the parity information release), the data previously associated with the parity information may not be protected by parity information and thus data may be lost in the case that an error or failure of the memory system may occur.

To protect the data, the memory system may initiate a parity information reconstruction event 345, which may result in a zone configuration 310-c. If there is no parity information stored in the volatile memory, there is a possibility that an error may occur in newly written data may be undetected. To increase the effectiveness of the parity information, new parity information may be generated from partial amounts of data stored in the zone configuration of the non-volatile memory. The memory system may utilize (e.g., retrieve) a portion of the stored data to generate the new parity information (e.g., generate second parity information) such that data stored in the non-volatile memory may be protected. In some cases, the memory system may utilize one or more (e.g., 2) of the word lines of data protected by parity information 320 and last written to regenerate portions of the parity information such that the memory system may correct one or more errors that occur when new data is written to the zone configuration 310-c.

The memory system may generate new parity information using a quantity of most-recently written word lines for each zone. In the illustrative example, the last two written word lines (when available) are used to generate the new parity information. Specifically, the new parity information is generated using word lines 5 and 6 of zone 0, word lines 8 and 9 of zone 1, word lines 5 and 6 of zone 2, word lines 3 and 4 of zone 3, word lines 6 and 7 of zone 4, word lines 4 and 5 of zone 5, word lines 7 and 8 of zone 6, and word lines 3 and 4 of zone 7. While generating the new parity information is shown as using data from two filled word lines from each zone with sufficient data stored to them, any quantity of word lines may be used to generate the new parity information. For example, the new parity information may be generated using one, two, three, four, five, six, seven, or eight filled word lines associate with one or more of the zones.

In some examples, the memory system may receive another write command upon generating the new parity information (e.g., generating the second parity information). The memory system may store data associated with the new write command to the zones 305 (e.g., write the data to the next write position 325 of the next zone 305 in the sequence) and may generate one or more other parity bits associated with the new data. The memory system may update the parity information (e.g., generate third parity information) associated with the zones 305 such that the new data and the stored data may be protected by parity information.

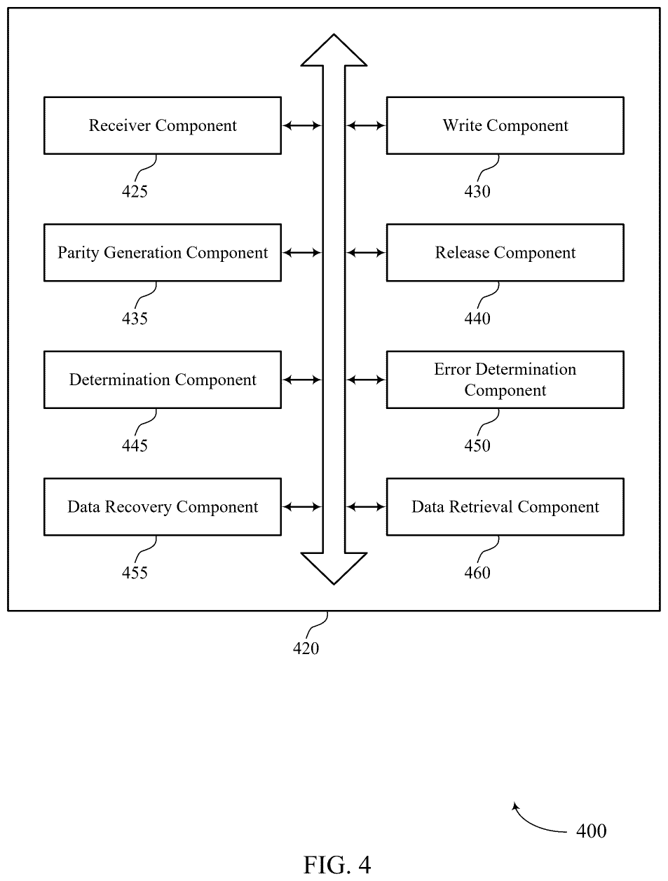

FIG. 4 shows a block diagram 400 of a memory system 420 that supports shared parity release and reconstruction in accordance with examples as disclosed herein. The memory system 420 may be an example of aspects of a memory system as described with reference to FIGS. 1 through 3. The memory system 420, or various components thereof, may be an example of means for performing various aspects of shared parity release and reconstruction as described herein. For example, the memory system 420 may include a receiver component 425, a write component 430, a parity generation component 435, a release component 440, a determination component 445, an error determination component 450, a data recovery component 455, a data retrieval component 460, or any combination thereof. Each of these components, or components of subcomponents thereof (e.g., one or more processors, one or more memories), may communicate, directly or indirectly, with one another (e.g., via one or more buses).

The receiver component 425 may be configured as or otherwise support a means for receiving a command to write data to a non-volatile memory device of the memory system. The write component 430 may be configured as or otherwise support a means for writing the data to the non-volatile memory device at a location indicated by a cursor stored in a volatile memory device of the memory system based at least in part on receiving the command, the cursor being one of a plurality of cursors stored in the volatile memory device. The parity generation component 435 may be configured as or otherwise support a means for generating first parity information using the data and a set of data indicated by the plurality of cursors. The release component 440 may be configured as or otherwise support a means for releasing the first parity information from the volatile memory device based at least in part on a size of the set of data used to generate the first parity information satisfying a threshold. In some examples, the parity generation component 435 may be configured as or otherwise support a means for generating, based at least in part on releasing the first parity information, second parity information including a first subset of the set of data indicated by the plurality of cursors associated with the first parity information.

In some examples, to support determining whether the size satisfies the threshold, the determination component 445 may be configured as or otherwise support a means for determining that the location indicated by the cursor is full of data, where the size is associated with a second subset of data indicated by the cursor satisfying the threshold associated with the cursor.

In some examples, to support determining whether the size satisfies the threshold, the determination component 445 may be configured as or otherwise support a means for determining that the set of data used to generate the first parity information indicated by the plurality of cursors satisfies the threshold, where the size is associated with the set of data indicated by the plurality of cursors satisfying the threshold associated with the plurality of cursors.

In some examples, to support determining whether the size satisfies the threshold, the determination component 445 may be configured as or otherwise support a means for determining whether the size of the set of data used to generate the first parity information satisfies the threshold based at least in part on generating the first parity information, where releasing the first parity information is based at least in part on the determination.

In some examples, the receiver component 425 may be configured as or otherwise support a means for receiving a second command to write second data to the non-volatile memory device of the memory system after generating the second parity information. In some examples, the write component 430 may be configured as or otherwise support a means for writing the second data to the location indicated by the cursor based at least in part on receiving the command. In some examples, the parity generation component 435 may be configured as or otherwise support a means for generating third parity information using the second data and the first subset of the set of data indicated by the plurality of cursors based at least in part on writing the second data to the location indicated by the cursor.

In some examples, each cursor of the plurality of cursors are associated with an independently controllable zoned namespaces of the non-volatile memory device.

In some examples, the write component 430 may be configured as or otherwise support a means for writing second data to a block indicated by the cursor. In some examples, the error determination component 450 may be configured as or otherwise support a means for determining that the second data includes one or more errors. In some examples, the data recovery component 455 may be configured as or otherwise support a means for recovering at least a portion of the first subset of the set of data using the second parity information based at least in part on determining that the second data indicated by the cursor includes the one or more errors.

In some examples, to support determining whether the size of the set of data used to generate the first parity information satisfies the threshold, the determination component 445 may be configured as or otherwise support a means for determining whether a quantity of word lines that store data used to generate the first parity information satisfies a threshold quantity of word lines.

In some examples, the quantity of word lines includes up to two word lines retrieved from each cursor of the plurality of cursors.

In some examples, the quantity of word lines includes up to two of word lines that were last written to each cursor of the plurality of cursors.

In some examples, to support generating the second parity information, the data retrieval component 460 may be configured as or otherwise support a means for retrieving the first subset of the set of data from a quantity of word lines associated with each cursor of the plurality of cursors stored in the volatile memory device, where the second parity information is generated using the first subset retrieved from the quantity of word lines.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

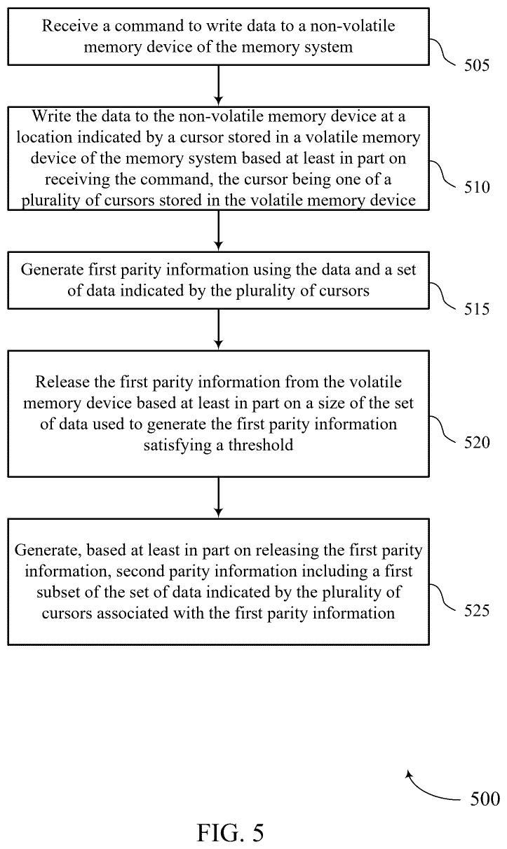

FIG. 5 shows a flowchart illustrating a method 500 that supports shared parity release and reconstruction in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a command to write data to a non-volatile memory device of the memory system. In some examples, aspects of the operations of 505 may be performed by a receiver component 425 as described with reference to FIG. 4.

At 510, the method may include writing the data to the non-volatile memory device at a location indicated by a cursor stored in a volatile memory device of the memory system based at least in part on receiving the command, the cursor being one of a plurality of cursors stored in the volatile memory device. In some examples, aspects of the operations of 510 may be performed by a write component 430 as described with reference to FIG. 4.

At 515, the method may include generating first parity information using the data and a set of data indicated by the plurality of cursors. In some examples, aspects of the operations of 515 may be performed by a parity generation component 435 as described with reference to FIG. 4.

At 520, the method may include releasing the first parity information from the volatile memory device based at least in part on a size of the set of data used to generate the first parity information satisfying a threshold. In some examples, aspects of the operations of 520 may be performed by a release component 440 as described with reference to FIG. 4.

At 525, the method may include generating, based at least in part on releasing the first parity information, second parity information including a first subset of the set of data indicated by the plurality of cursors associated with the first parity information. In some examples, aspects of the operations of 525 may be performed by a parity generation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to write data to a non-volatile memory device of the memory system; writing the data to the non-volatile memory device at a location indicated by a cursor stored in a volatile memory device of the memory system based at least in part on receiving the command, the cursor being one of a plurality of cursors indicated by the volatile memory device; generating first parity information using the data and a set of data stored in the plurality of cursors; releasing the first parity information from the volatile memory device based at least in part on a size of the set of data used to generate the first parity information satisfying a threshold; and generating, based at least in part on releasing the first parity information, second parity information including a first subset of the set of data indicated by the plurality of cursors associated with the first parity information.

Aspect 2: The method, apparatus, or non-transitory computer-readable medium of aspect 1, where determining whether the size satisfies the threshold further includes operations, features, circuitry, logic, means, or instructions, or any combination thereof for determining that the location indicated by the cursor is full of data, where the size is associated with a second subset of data indicated by the cursor satisfying the threshold associated with the cursor.

Aspect 3: The method, apparatus, or non-transitory computer-readable medium of any of aspects 1 through 2, where determining whether the size satisfies the threshold further includes operations, features, circuitry, logic, means, or instructions, or any combination thereof for determining that the set of data used to generate the first parity information indicated by the plurality of cursors satisfies the threshold, where the size is associated with the set of data indicated by the plurality of cursors satisfying the threshold associated with the plurality of cursors.

Aspect 4: The method, apparatus, or non-transitory computer-readable medium of any of aspects 1 through 3, where determining whether the size satisfies the threshold further includes operations, features, circuitry, logic, means, or instructions, or any combination thereof for determining whether the size of the set of data used to generate the first parity information satisfies the threshold based at least in part on generating the first parity information, where releasing the first parity information is based at least in part on the determination.

Aspect 5: The method, apparatus, or non-transitory computer-readable medium of any of aspects 1 through 4, further including operations, features, circuitry, logic, means, or instructions, or any combination thereof for receiving a second command to write second data to the non-volatile memory device of the memory system after generating the second parity information; writing the second data to the location indicated by the cursor based at least in part on receiving the command; and generating third parity information using the second data and the first subset of the set of data indicated by the plurality of cursors based at least in part on writing the second data to the location indicated by the cursor.

Aspect 6: The method, apparatus, or non-transitory computer-readable medium of any of aspects 1 through 5, where each cursor of the plurality of cursors are associated with an independently controllable zoned namespaces of the non-volatile memory device.

Aspect 7: The method, apparatus, or non-transitory computer-readable medium of any of aspects 1 through 6, further including operations, features, circuitry, logic, means, or instructions, or any combination thereof for writing second data to a block indicated by the cursor; determining that the second data includes one or more errors; and recovering at least a portion of the first subset of the set of data using the second parity information based at least in part on determining that the second data stored in the cursor includes the one or more errors.

Aspect 8: The method, apparatus, or non-transitory computer-readable medium of any of aspects 1 through 7, where determining whether the size of the set of data used to generate the first parity information satisfies the threshold further includes operations, features, circuitry, logic, means, or instructions, or any combination thereof for determining whether a quantity of word lines that store data used to generate the first parity information satisfies a threshold quantity of word lines.

Aspect 9: The method, apparatus, or non-transitory computer-readable medium of aspect 8, where the quantity of word lines includes up to two word lines retrieved from each cursor of the plurality of cursors.

Aspect 10: The method, apparatus, or non-transitory computer-readable medium of any of aspects 8 through 9, where the quantity of word lines includes up to two of word lines that were last written to each cursor of the plurality of cursors.

Aspect 11: The method, apparatus, or non-transitory computer-readable medium of any of aspects 1 through 10, where generating the second parity information further includes operations, features, circuitry, logic, means, or instructions, or any combination thereof for retrieving the first subset of the set of data from a quantity of word lines associated with each cursor of the plurality of cursors stored in the volatile memory device, where the second parity information is generated using the first subset retrieved from the quantity of word lines.

Aspect 12: The method, apparatus, or non-transitory computer-readable medium of any of aspects 1 through 11, where releasing the first parity information further includes operations, features, circuitry, logic, means, or instructions, or any combination thereof for crasing the first parity information from the volatile memory device.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
receiving a command to write data to a non-volatile memory device of the memory system;
writing the data to the non-volatile memory device at a location indicated by a cursor stored in a volatile memory device of the memory system based at least in part on receiving the command, the cursor being one of a plurality of cursors stored in the volatile memory device;
generating first parity information using the data and a set of data indicated by the plurality of cursors;
releasing the first parity information from the volatile memory device based at least in part on a size of the set of data used to generate the first parity information satisfying a threshold; and
generating, based at least in part on releasing the first parity information, second parity information comprising a first subset of the set of data indicated by the plurality of cursors associated with the first parity information.

2. The method of claim 1, wherein determining whether the size satisfies the threshold further comprises:
determining that the location indicated by the cursor is full of data, wherein the size is associated with a second subset of data indicated by the cursor satisfying the threshold associated with the cursor.

3. The method of claim 1, wherein determining whether the size satisfies the threshold further comprises:
determining that the set of data used to generate the first parity information indicated by the plurality of cursors satisfies the threshold, wherein the size is associated with the set of data indicated by the plurality of cursors satisfying the threshold associated with the plurality of cursors.

4. The method of claim 1, wherein determining whether the size satisfies the threshold further comprises:
determining whether the size of the set of data used to generate the first parity information satisfies the threshold based at least in part on generating the first parity information, wherein releasing the first parity information is based at least in part on the determination.

5. The method of claim 1, further comprising:
receiving a second command to write second data to the non-volatile memory device of the memory system after generating the second parity information;
writing the second data to the location indicated by the cursor based at least in part on receiving the command; and
generating third parity information using the second data and the first subset of the set of data indicated by the plurality of cursors based at least in part on writing the second data to the location indicated by the cursor.

6. The method of claim 1, wherein each cursor of the plurality of cursors are associated with an independently controllable zoned namespaces of the non-volatile memory device.

7. The method of claim 1, further comprising:
writing second data to a block indicated by the cursor;
determining that the second data comprises one or more errors; and
recovering at least a portion of the first subset of the set of data using the second parity information based at least in part on determining that the second data indicated by the cursor comprises the one or more errors.

8. The method of claim 1, wherein determining whether the size of the set of data used to generate the first parity information satisfies the threshold further comprises:
determining whether a quantity of word lines that store data used to generate the first parity information satisfies a threshold quantity of word lines.

9. The method of claim 8, wherein the quantity of word lines comprises up to two word lines retrieved from each cursor of the plurality of cursors.

10. The method of claim 8, wherein the quantity of word lines comprises up to two of word lines that were last written to each cursor of the plurality of cursors.

11. The method of claim 1, wherein generating the second parity information further comprises:
retrieving the first subset of the set of data from a quantity of word lines associated with each cursor of the plurality of cursors stored in the volatile memory device, wherein the second parity information is generated using the first subset retrieved from the quantity of word lines.

12. The method of claim 1, wherein releasing the first parity information further comprises:
erasing the first parity information from the volatile memory device.

13. A non-transitory computer-readable medium storing code, the code comprising instructions executable by one or more processors to:
receive a command to write data to a non-volatile memory device of a memory system;
write the data to the non-volatile memory device at a location indicated by a cursor stored in a volatile memory device of the memory system based at least in part on receiving the command, the cursor being one of a plurality of cursors stored in the volatile memory device;
generate first parity information using the data and a set of data indicated by the plurality of cursors;
release the first parity information from the volatile memory device based at least in part on a size of the set of data used to generate the first parity information satisfying a threshold; and
generate, based at least in part on releasing the first parity information, second parity information comprising a first subset of the set of data indicated by the plurality of cursors associated with the first parity information.

14. The non-transitory computer-readable medium of claim 13, wherein the instructions to determine whether the size satisfies the threshold are further executable by the one or more processors to:
determine that the location indicated by the cursor is full of data, wherein the size is associated with a second subset of data indicated by the cursor satisfying the threshold associated with the cursor.

15. The non-transitory computer-readable medium of claim 13, wherein the instructions to determine whether the size satisfies the threshold are further executable by the one or more processors to:
determine that the set of data used to generate the first parity information indicated by the plurality of cursors satisfies the threshold, wherein the size is associated with the set of data indicated by the plurality of cursors satisfying the threshold associated with the plurality of cursors.

16. The non-transitory computer-readable medium of claim 13, wherein the instructions to determine whether the size satisfies the threshold are further executable by the one or more processors to:
determine whether the size of the set of data used to generate the first parity information satisfies the threshold based at least in part on generating the first parity information, wherein releasing the first parity information is based at least in part on the determination.

17. The non-transitory computer-readable medium of claim 13, wherein the instructions are further executable by the one or more processors to:
receive a second command to write second data to the non-volatile memory device of the memory system after generating the second parity information;
write the second data to the location indicated by the cursor based at least in part on receiving the command; and
generate third parity information using the second data and the first subset of the set of data indicated by the plurality of cursors based at least in part on writing the second data to the location indicated by the cursor.

18. The non-transitory computer-readable medium of claim 13, wherein each cursor of the plurality of cursors are associated with an independently controllable zoned namespaces of the non-volatile memory device.

19. A memory system, comprising:
one or more memory devices; and
processing circuitry coupled with the one or more memory devices and configured to cause the memory system to:
receive a command to write data to a non-volatile memory device of the memory system;
write the data to the non-volatile memory device at a location indicated by a cursor stored in a volatile memory device of the memory system based at least in part on receiving the command, the cursor being one of a plurality of cursors stored in the volatile memory device;
generate first parity information using the data and a set of data indicated by the plurality of cursors;
release the first parity information from the volatile memory device based at least in part on a size of the set of data used to generate the first parity information satisfying a threshold; and
generate, based at least in part on transferring the first parity information, second parity information comprising a first subset of the set of data indicated by the plurality of cursors associated with the first parity information.

20. The memory system of claim 19, wherein, to determine whether the size satisfies the threshold, the processing circuitry is configured to cause the memory system to:
determining that the location indicated by the cursor is full of data, wherein the size is associated with a second subset of data indicated by the cursor satisfying the threshold associated with the cursor.

21. The memory system of claim 19, wherein, to determine whether the size satisfies the threshold, the processing circuitry is configured to cause the memory system to:
determining that the set of data used to generate the first parity information indicated by the plurality of cursors satisfies the threshold, wherein the size is associated with the set of data indicated by the plurality of cursors satisfying the threshold associated with the plurality of cursors.

22. The memory system of claim 19, wherein, to determine whether the size satisfies the threshold, the processing circuitry is configured to cause the memory system to:
determining whether the size of the set of data used to generate the first parity information satisfies the threshold based at least in part on generating the first parity information, wherein releasing the first parity information is based at least in part on the determination.

23. The memory system of claim 19, wherein the processing circuitry is further configured to cause the memory system to:
receiving a second command to write second data to the non-volatile memory device of the memory system after generating the second parity information;
writing the second data to the location indicated by the cursor based at least in part on receiving the command; and
generating third parity information using the second data and the first subset of the set of data indicated by the plurality of cursors based at least in part on writing the second data to the location indicated by the cursor.

24. The memory system of claim 19, wherein each cursor of the plurality of cursors are associated with an independently controllable zoned namespaces of the non-volatile memory device.
